(19) United States
(12) Patent Application Publication
(10) Pub. No.: US 2006/0202979 A1
(43) Pub. Date: Sep. 14, 2006

(54) Video display control device and video display device

(76) Inventors: Nobuhiro Manabe, Kanagawa (JP); Norikatsu Uchiyamada, Kanagawa (JP); Takashi Okohira, Kanagawa (JP)

Correspondence Address: RATNERPRESTIA, P.O. BOX 980, VALLEY FORGE, PA, 19482, US

(21) Appl. No.: 11/369,623

(22) Filed: Mar. 7, 2006

(30) Foreign Application Priority Data
Mar. 7, 2005 (JP) P. 2005-062570

(51) Int. Cl. G09G 5/00

(52) U.S. Cl. 345/204

(57) ABSTRACT

A video display control device is capable of driving plural types of video display units by one type of decoder. A video display control device (a control unit) includes a decoder for separating a composite video signal having a video signal and a synchronizing signal which are input into a horizontal synchronizing signal, a vertical synchronizing signal and a color signal, and generating a dot clock signal from the horizontal synchronizing signal and the vertical synchronizing signal, and a timing signal converting unit having storage areas capable of writing a signal converting program for converting the dot clock signal. The video display control device is connected to different display units.

### BACKGROUND OF THE INVENTION

The present invention relates to a video display device for displaying a video on a display unit that carries out a dot matrix display by using a video signal, and more particularly to a video display control device to be used for the video display device.

FIG. 7 shows a related video display device. In FIG. 7, a related video display device 100 separates a composite video signal output from a DVD (Digital Versatile Disc) reproducing device into a color signal (RGB), a horizontal synchronizing signal and a vertical synchronizing signal by a decoder 101.

In order to display a video on a video display unit 102, a horizontal synchronizing signal (H) and a vertical synchronizing signal (V) which are synchronized with the video signal and a dot clock signal (D) corresponding to the number of pixels are required. Furthermore, these signals have different timings depending on a type of the video display unit 102. Therefore, it has been known that the horizontal synchronizing signal and the vertical synchronizing signal create a timing signal which is dedicated to and required for the video display unit 102 in the decoder 101 and the color signal and the timing signal which are exactly input to the video display portion 102 are used exactly after a separation to display a video on the display unit for carrying out a dot matrix display (for example, see JP-A-2003-204529).

When the video display device is used, however, a horizontal synchronizing signal and a vertical synchronizing signal which are synchronized with an input video signal and a dot clock signal corresponding to the number of display pixels are required. Consequently, a signal timing and the number of pixels are varied for each video display unit. For this reason, it is necessary to use a dedicated decoder for outputting the horizontal synchronizing signal, the vertical synchronizing signal and the dot clock signal corresponding to the video display unit to be used. Therefore, there is a problem in that plural types of video display units cannot be driven by one type of decoder.

### SUMMARY OF THE INVENTION

The invention has been made in order to solve the conventional problems and has an object to provide a video display control device capable of driving plural types of video display units by one type of decoder, and a video display device using the video display control device.

A video display control device according to the invention includes a decoder for separating a composite video signal including a video signal and a synchronizing signal which are input into a horizontal synchronizing signal, a vertical synchronizing signal and a color signal and generating a dot clock signal, and a timing signal converting unit having a storage area capable of writing a signal converting program for converting at least one of the dot clock signal, the horizontal synchronizing signal and the vertical synchronizing signal.

By this structure, the signal converting program corresponding to the video display unit can be written. Therefore, it is possible to use plural types of video display units by one type of video display unit dedicated decoder.

Moreover, the timing signal converting unit can be provided with a plurality of storage areas.

By this structure, it is possible to utilize different types of video display units.

Furthermore, the video display control device can be provided with a switch for selecting any one of the storage areas.

By this structure, it is possible to select one of proper signal converting programs.

Furthermore, the video display control device according to the invention can be provided with an input unit for inputting a video signal which is output from a portable information terminal.

By this structure, it is possible to watch and hear, in a suitable size, a video output through the portable information terminal with a simple structure.

The video display control device according to the invention can be applied to a control of a display unit provided in a vehicle compartment.

By this structure, the display unit to be mounted on a vehicle can be used in a plurality of types by means of one type of video display unit dedicated decoder.

Moreover, the video display device according to the invention has the video display control device and a display unit for displaying a video signal converted by the timing signal converting unit.

Another video display device according to the invention has the video display control device and a display unit which serves to display a video signal converted by the timing signal converting unit and can be attached and removed.

By this structure, it is possible to utilize plural types of different video display units.

Furthermore, a further video display device according to the invention has the video display control device and a plurality of display units for displaying a video signal converted by the timing signal converting unit.

By this structure, it is possible to simultaneously display the same video information on plural types of different video display units.

The invention can provide a video display control device in which a signal converting unit is disposed between a video display unit and a video display dedicated decoder and plural types of video display units can be thus used by one type of video display unit dedicated decoder, and a video display device.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a block diagram showing a video display device according to a first embodiment of the invention;

FIG. 2 is a timing chart for explaining an operation of the video display device according to the first embodiment of the invention;

FIG. 3 is a view showing a structure of the video display device according to the first embodiment of the invention;

FIG. 4 is a diagram showing the structure of the video display device according to the first embodiment of the invention;

FIG. 5 is a view showing a structure of a video display device according to a second embodiment of the invention;

FIG. 6 is a block diagram showing the video display device according to the second embodiment of the invention; and

FIG. 7 is a block diagram showing a conventional video display device.

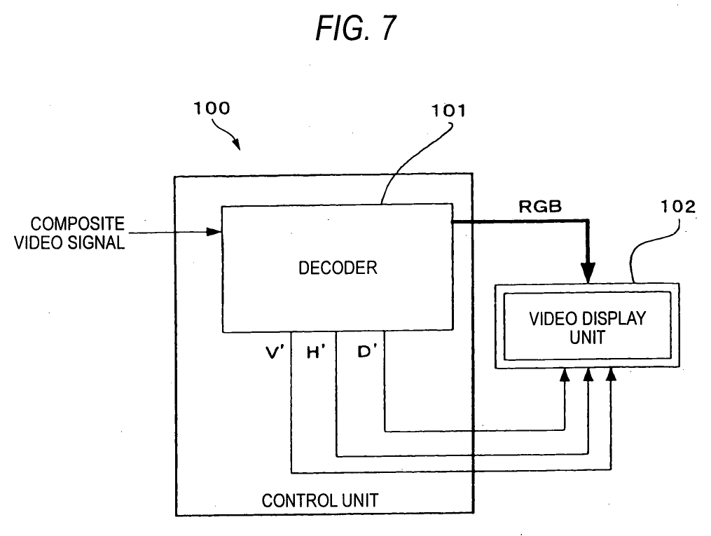

### DETAILED DESCRIPTION OF THE PREFERRED EMBODIMENTS

### First Embodiment

A video display control device and a video display device according to a first embodiment of the invention will be described below with reference to the drawings.

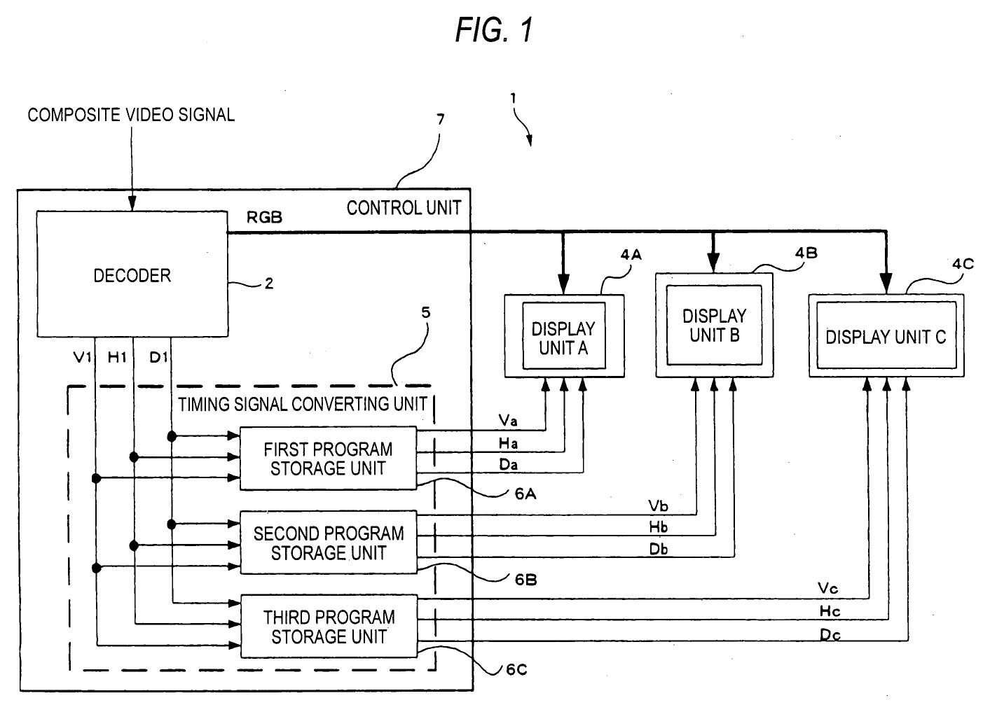

FIG. 1 is a block diagram showing a video display device according to the embodiment of the invention. The video display device 1 includes a control unit (a video display control device) 7, and a video display unit 4 (4A, 4B, 4C) constituted by a liquid crystal display. The control unit 7 includes a decoder 2 and a timing signal converting unit 5. Furthermore, the timing signal converting unit 5 includes a first program storage unit 6A, a second program storage unit 6B and a third program storage unit 6C.

In FIG. 1, the decoder 2 adapts, to a dedicated video display unit, a composite video signal obtained by combining a synchronizing signal and a video signal which are sent from a video camera or a DVD reproducing device and separates the composite video signal into a horizontal synchronizing signal H1, a vertical synchronizing signal V1 and a color signal RGB which serve to display a video, and a dot clock signal D1 to be adapted to the number of display pixels synchronously with the horizontal synchronizing signal H1 and the vertical synchronizing signal V1. More specifically, the composite video signal obtained by combining the synchronizing signal and the video signal which are sent from the video camera or the DVD is adapted to the dedicated video display unit and is separated into a horizontal synchronizing signal H, a vertical synchronizing signal V and the color signal RGB which serve to display a video, and the horizontal synchronizing signal H1, the vertical synchronizing signal V1 and the dot clock signal D1 for displaying a video on the dedicated video display unit 4 are generated by a timing signal generating function in the decoder 2 from the horizontal synchronizing signal H and the vertical synchronizing signal V which are thus separated. The timing signal converting unit 5 serves to convert the timings of the horizontal synchronizing signal, the vertical synchronizing signal and the dot clock signal into a signal for displaying a video on the video display unit 4 which is connected. The video display unit 4 serves to display videos which are simultaneously input synchronously with the horizontal synchronizing signal H1, the vertical synchronizing signal V1 and the dot clock signal D1.

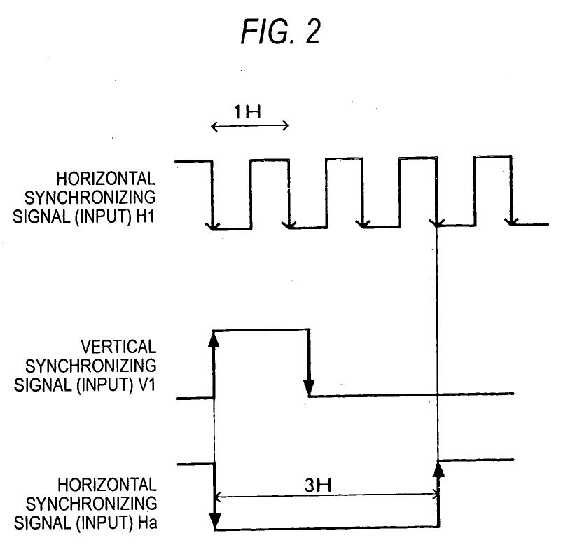

With reference to FIGS. 1 and 2, description will be given to an operation of the video display device having the structure. A composite video signal output from a DVD reproducing device and obtained by combining a synchronizing signal and a video synchronizing signal is separated into the color signal RGB, and the horizontal and vertical synchronizing signals H and V to be the synchronizing signals by the decoder 2. By these signals, the horizontal synchronizing signal H1 and the vertical synchronizing signal V1 for displaying the horizontal synchronizing signal H and the vertical synchronizing signal V on the video display unit and the dot clock signal D1 corresponding to the number of display pixels are generated and sent to the timing signal converting unit 5. On the other hand, the color signal RGB is directly sent to the video display unit 4.

As described above, the timing signal converting unit 5 includes first to third program storage units (signal converters) 6A, 6B and 6C, having storage areas for writing a signal converting program to display a video on plural types of display units. For example, in the case that three types of different video display units A, B and C are provided as shown in FIG. 1, dedicated signal converting programs corresponding to the respective video display units 4A, 4B and 4C are written to the program storage units 6A, 6B and 6C of the timing signal converting unit 5. Consequently, the horizontal synchronizing signal H1, the vertical synchronizing signal V1 and the dot clock signal D1 which are sent from the decoder 2 are converted into three kinds of horizontal synchronizing signals Ha, Hb and Hc, three kinds of vertical synchronizing signals Va, Vb and Vc, and three kinds of dot clock signals Da, Db and Dc, and are sent to the video display units 4A, 4B and 4C at the same time, respectively. By using these signals and the color signal RGB, a video can be displayed at the same time on the video display units A, B and C.

Next, an operation in the video display device according to the embodiment will be described with reference to FIG. 2.

Description will be given by taking the horizontal synchronizing signal Ha. First, a program for a video display which is dedicated to the connected video display unit 4A is written to the timing signal converting unit 5 by using an external PC. Consequently, a conversion into the horizontal synchronizing signal Ha to be an output is carried out by the horizontal synchronizing signal H1 and the vertical synchronizing signal V1 which are input. At this time, the timing of the horizontal synchronizing signal H1 which is output falls in a rise in the vertical synchronizing signal V1 which is input, and rises in a fall in a third H of the horizontal synchronizing signal H1 which is input. A timing is converted in accordance with the program written to the timing signal converting unit in response to the input signal so that other output signals are generated in the same manner. The program is varied for each video display unit to be connected, that is, differs in the video display units 4A, 4B and 4C, respectively. Therefore, a user can rewrite the program for the video display in the timing signal converting unit 5 for each video display unit through the external PC.

According to the embodiment described above, the video display control device is configured so as to include the decoder for separating the composite video signal obtained by combining the synchronizing signal and the video signal which are sent from a video information source such as a DVD reproducing device into the horizontal synchronizing signal H, the vertical synchronizing signal V and the color signal RGB, generating the horizontal synchronizing signal H1 and the vertical synchronizing signal V1 for projecting the horizontal synchronizing signal H and the vertical synchronizing signal V which are sent onto the dedicated video display, and generating and outputting the dot clock signal which is synchronous with these synchronizing signals and corresponds to the number of display pixels, and the timing signal converting unit 5 having the storage unit 6 capable of converting the timings of the horizontal synchronizing signal H1, the vertical synchronizing signal V1 and the dot clock signal D1 which are sent into the signals for displaying a video on the video display unit which is connected and outputting them, and displaying a video on the plural kinds of video display units 4. Furthermore, the video display control device includes the video display units 4 for displaying a video signal sent synchronously with the horizontal synchronizing signal, the vertical synchronizing signal and the dot clock signal which are sent from the video display control device. Therefore, it is possible to simultaneously display the plural types of video display units 4 having different specifications through one type of video display unit dedicated decoder 2.

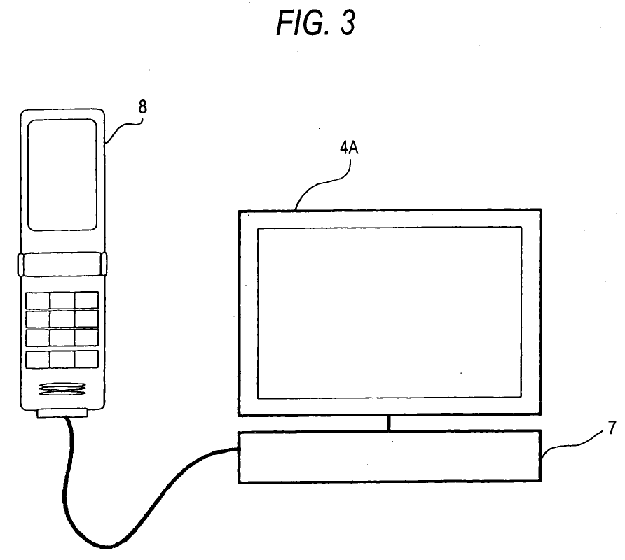

As shown in FIG. 3, moreover, a composite video signal can be fetched from an information terminal device having a small display screen, for example, a cell phone and the displayed contents can be displayed on the larger video display unit 4A and can easily be seen. By utilizing a navigation service for the cell phone, it is possible to carry out a simple use as a car navigation device. The control unit 7 is provided with an input unit constituted by an input port for inputting a video signal output from the portable information terminal so that a utilization shown in FIG. 3 can be carried out.

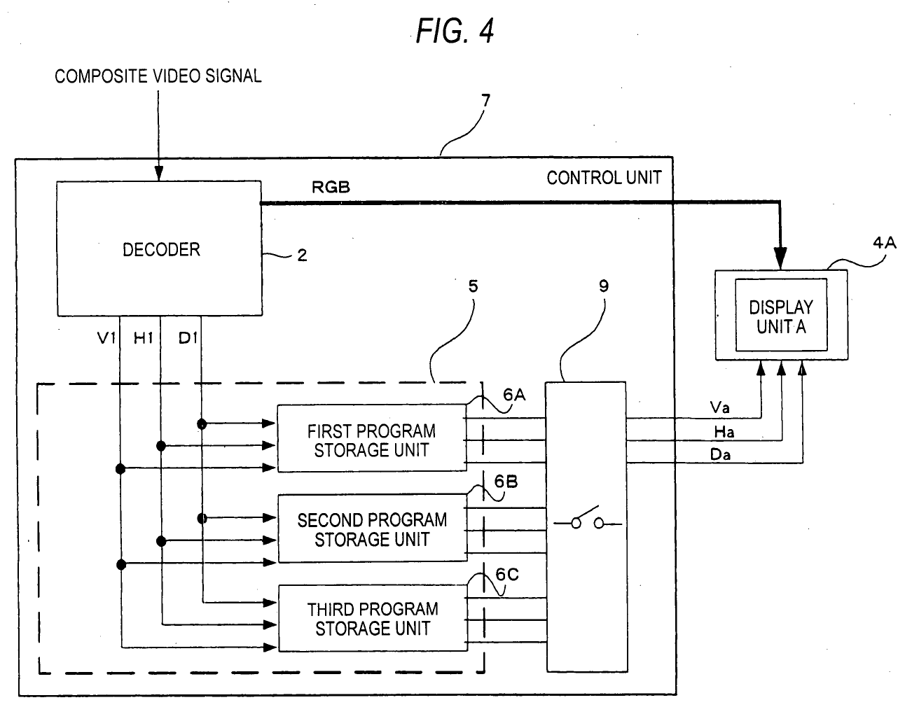

Furthermore, the three types of display units do not need to be connected. For example, as shown in FIG. 4, the display unit is detachably connected to the control unit through a connector, and it is possible to use many types of display units corresponding to a user's taste if a switching unit such as a switch 9 is used to freely change over the outputs of (Va, Ha, Da), (Vb, Hb, Db) and (Vc, Hc, Dc), that is, to freely select a proper one of the signal converting programs stored in the first to third program storage units.

While the horizontal synchronizing signal, the vertical synchronizing signal and the dot clock signal are converted by the timing signal converting unit 5 in the embodiment, it is preferable that one of the signals should be converted if all of them do not particularly need to be converted.

### Second Embodiment

A video display system according to a second embodiment of the invention applies the video display device according to the first embodiment, and description will be given by using the same reference numerals for the same portions as those in the first embodiment.

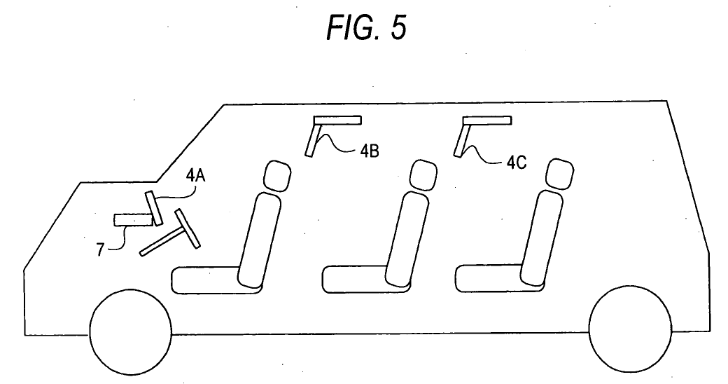

FIG. 5 is a diagram showing a structure of a video display device according to the embodiment of the invention.

As shown in FIG. 5, the video display device has a plurality of display units in a compartment of a car which is provided in such a manner that a passenger taking a seat in a front row, a passenger taking a seat in a second row and a passenger taking a seat in a third row can carry out seeing and hearing, respectively. More specifically, a display unit 4A is mounted on an upper stage side of a center of a front panel in the car in order for a driver and a passenger taking a passenger seat to carry out the seeing and hearing, and display units 4B and 4C are provided on ceiling surfaces placed slightly forward from the respective seats in the car in order for the passengers taking the seat in the second and third rows to carry out the seeing and hearing. In this case, the display units 4B and 4C for the seats in the second and third rows may be buried in headrests of the seats in the front rows, respectively.

In many cases, another onboard AV apparatus is usually mounted on the front panel portion. In the embodiment, therefore, a control unit is disposed in this portion.

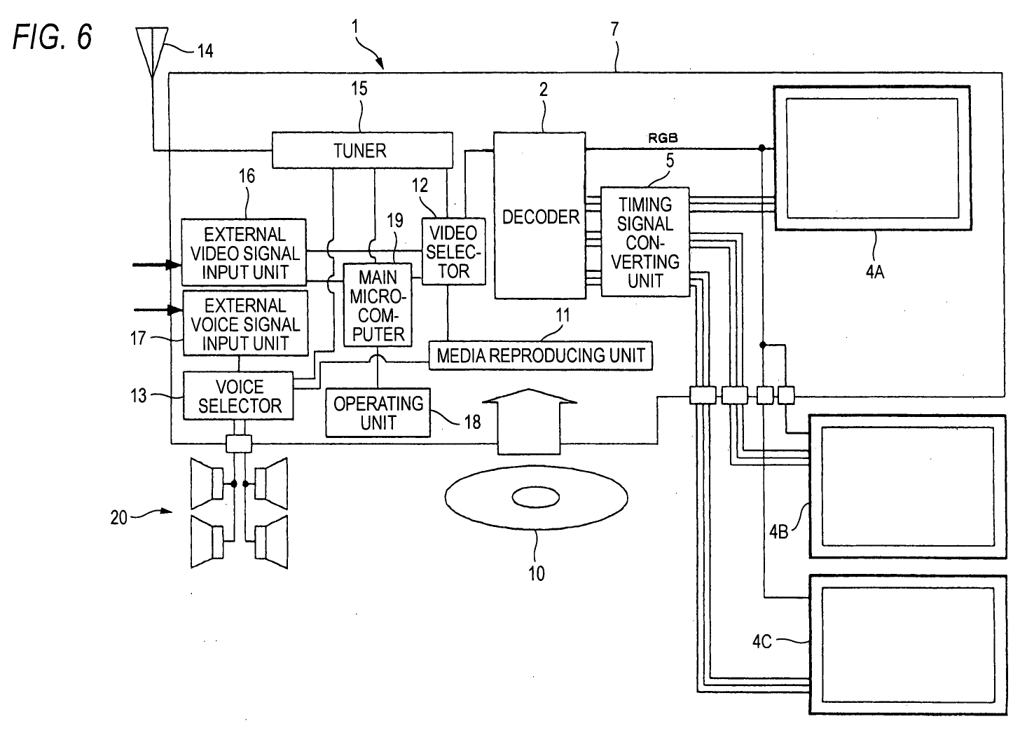

FIG. 6 is a block diagram showing the video display system.

In FIG. 6, the video display device according to the embodiment is provided with a media reproducing unit 11 for reproducing media such as a DVD 10. The video display device decodes a signal obtained from the media 10 reproduced in the media reproducing unit 11 and outputs a composite video signal obtained by combining a synchronizing signal and a video signal and a voice signal to a video selector 12 and a voice selector 13, respectively. The video selector 12 and the voice selector 13 input a signal obtained by decoding a received wave of a TV broadcast which is received through an antenna 14 and is controlled by a tuner 15 and a composite video signal of a video camera connected to an external video signal input unit 16 and an external voice signal input unit 17, respectively. An operator operates an operating unit 18 to select any of a media reproducing mode for watching and hearing the reproduced contents of the media, an external apparatus mode for watching and hearing an acoustic video sent from an external apparatus and a TV mode for watching and hearing the contents of the TV broadcast. Any of them selected by the operator is detected by a main microcomputer 19 and a notice is given to the video selector 12 and the voice selector 13. Consequently, a voice output from the voice selector 13 from which a composite video and a voice in the selected mode are output respectively is output from a speaker 20 and can be heard with a volume regulated by an indicating signal sent from the operating unit 18 and a volume regulating unit such as a DSP (Digital Sound Processor) or an electronic volume (not shown) in order to have a desirable volume for the operator.

On the other hand, the composite video signal output from the video selector is adapted to the dedicated video display unit and is separated into a horizontal synchronizing signal H1, a vertical synchronizing signal V1 and a color signal RGB for projecting a video, and a dot clock signal D1 to be adapted to the number of display pixels synchronously with the horizontal synchronizing signal H1 and the vertical synchronizing signal V1. More specifically, the composite video signal is adapted to the dedicated video display unit and is separated into a horizontal synchronizing signal H, a vertical synchronizing signal V and the color signal RGB for projecting the video, and the horizontal synchronizing signal H1, the vertical synchronizing signal V1 and the dot clock signal D1 for displaying the video on a dedicated video display unit 4 are generated by the timing signal generating function in a decoder 2 from the horizontal synchronizing signal H and the vertical synchronizing signal V which are separated. A timing signal converting unit 5 has a storage unit 6 (FIGS. 1 and 4; 6A, 6B, 6C) capable of writing a signal converting program for displaying a video in plural types of display devices. In case of the structure having three types of video display units 4A, 4B and 4C which are different from each other, the signal converting programs for 4A, 4B and 4C corresponding to the respective video display units are written to the program storage unit in the timing signal converting unit. Consequently, the horizontal synchronizing signal H1, the vertical synchronizing signal V1 and the dot clock signal D1 which are sent from the generating portion of the decoder 2 are converted into three kinds of horizontal synchronizing signals Ha, Hb and Hc, three kinds of vertical synchronizing signals Va, Vb and Vc and three kinds of dot clock signals Da, Db and Dc, and they are sent to the video display unit 4 at the same time, respectively. By using these signals and the color signal RGB, the video can be displayed at the same time in the respective video display units 4A, 4B and 4C.

According to the embodiments described above, the video display control device is configured so as to includes the decoder 2 for separating the composite video signal obtained by compositing the synchronizing signal and the video signal which are sent from the predetermined video information source into the horizontal synchronizing signal H, the vertical synchronizing signal V and the color signal RGB, generating the horizontal synchronizing signal H1 and the vertical synchronizing signal V1 for projecting the horizontal synchronizing signal H and the vertical synchronizing signal V which are sent onto the dedicated video display, and generating and outputting the dot clock signal which is synchronous with the synchronizing signals and corresponds to the number of display pixels, and the timing signal converting unit 5 having the storage unit 6 capable of converting the timings of the horizontal synchronizing signal H1, the vertical synchronizing signal V1 and the dot clock signal D1 which are sent into the signals for displaying a video on the video display unit 4 which is connected and outputting them, and writing a signal converting program for displaying a video on the plural kinds of video display units. Furthermore, the video display control device includes the video display units 4 for displaying a video signal sent synchronously with the horizontal synchronizing signal, the vertical synchronizing signal and the dot clock signal which are sent from the video display control device. Therefore, it is possible to simultaneously display the plural types of video display units 4 having different specifications through the generating portion of one type of video display unit dedicated decoder 2.

Furthermore, the three types of display units do not need to be connected and the display unit is removably connected to the control unit through a connector, and it is possible to use many types of display units corresponding to a user's taste if switching means (FIG. 4) such as a switch is used to freely change over the outputs of (Va, Ha, Da), (Vb, Hb, Db) and (Vc, Hc, Dc).

By using the video display control device and the video display device according to the invention, it is possible to apply to various video display units including a small-sized and inexpensive unit and a large-sized unit, a unit having the small number of dots and low picture quality and a unit having a large number of dots and capable of displaying a video of high quality, and a unit giving a different tone of a color depending on an angle of field and a unit having a small difference in the tone of a color depending on a difference in the angle of field. Consequently, it is possible to select and use any of the various display units in respect of a cost and a performance according to a self-taste. In an onboard video display device, particularly, a large-sized display unit can be attached in order to enjoy a video in a rear seat, a display unit having a high visibility can be particularly attached in the case in which a car navigation device is used for a driver or a passenger in a passenger seat or a display unit capable of expressing a tone of a color corresponding to a personal taste can be utilized.

As described above, the video display control device and the video display device according to the invention have an advantage that a video can be simultaneously displayed on plural types of video display units by one type of decoder, and are useful for seeing and hearing the video in a rear seat of a vehicle through a car navigation device or an RSE (Rear Sheet Entertainment) device using plural types of display units.

While various embodiments according to the invention have been described above, the invention is not restricted to matters described in the embodiments but is intended for the skilled in the art to make changes and applications based on claims and the description of this specification, and well-known techniques without departing from the scope of the invention.

The present application is based on Japan Patent Application No. 2005-062570 filed on Mar. 7, 2006, the contents of which are incorporated herein for reference.
1 video display device
2 decoder
4 display unit
5 timing signal converting unit
6 program storage unit
7 control unit
8 portable information terminal
9 switch unit
10 media
11 media reproducing unit
12 video selector
13 voice selector
14 antenna
15 tuner
16 external video signal input unit
17 external voice signal input unit
18 operating unit
19 main microcomputer
20 speaker
100 video display device
101 decoder
102 video display unit

What is claimed is:

1. A video display control device, comprising:
a decoder that separates a composite video signal including a video signal and a synchronizing signal which are input into a horizontal synchronizing signal, a vertical synchronizing signal and a color signal, and generates a dot clock signal; and
a timing signal converting unit that has a storage area capable of writing a signal converting program for converting at least one of the dot clock signal, the horizontal synchronizing signal and the vertical synchronizing signal.

2. The video display control device according to claim 1, wherein the timing signal converting unit has a plurality of the storage areas.

3. The video display control device according to claim 2, further comprising a switch that selects any one of the storage areas.

4. The video display control device according to claim 1, further comprising an input unit that inputs a video signal which is output from a portable information terminal.

5. The video display control device according to claim 1, further comprising a control unit for controlling a display unit provided in a compartment of a vehicle.

6. A video display device, comprising:
a decoder that separates a composite video signal including a video signal and a synchronizing signal which are input into a horizontal synchronizing signal, a vertical synchronizing signal and a color signal, and generates a dot clock signal;
a timing signal converting unit that has a storage area capable of writing a signal converting program for converting at least one of the dot clock signal, the horizontal synchronizing signal and the vertical synchronizing signal; and
a display unit that displays a video signal converted by the timing signal converting unit.

7. The video display device according to claim 6, wherein the display unit is detachably provided.

8. The video display device according to claim 6, further comprising a plurality of the display unit for displaying the video signal converted by the timing signal converting unit.
